(19) United States
(12) Patent Application Publication
(10) Pub. No.: US 2014/0209671 A1
(43) Pub. Date: Jul. 31, 2014

(54) System for Transferring Maps to a Mobile Device Without Network Connectivity Using Matrix Bar Codes or Other Passive Data Media

(71) Applicant: QUALCOMM INCORPORATED, San Diego, CA (US)

(72) Inventors: Keir Finlow-Bates, Kangasala (FI); Joonas Viskari, Tampere (FI)

(73) Assignee: QUALCOMM INCORPORATED, San Diego, CA (US)

(21) Appl. No.: 13/754,636

(22) Filed: Jan. 30, 2013

(51) Int. Cl. G06Q 50/30; G06K 7/14

(52) U.S. Cl. CPC G06Q 50/30; G06K 7/1417
USPC 235/375

(57) ABSTRACT

Methods, systems, computer-readable media, and apparatuses for transferring maps to a mobile device without network connectivity using matrix bar codes or other passive data media are presented. In some embodiments, such a method may include receiving data from an image scanner configured to scan a bar code, the data comprising a complete encoded map; processing the data to generate a decoded map; and displaying the decoded map to a user.

### BACKGROUND

Aspects of the disclosure relate to systems for transferring maps to a computing device. Modern offices and public buildings often have complicated layouts, which are not easy to navigate without a map. Traditionally, large buildings present these maps as printed leaflets at an entrance or a printed board within the building. Other approaches involve downloading a map to a user's mobile device via a network connection. While it is convenient to present maps on a mobile device, network connectivity is not always available and, even if available, can require extra steps such as a log in process, etc. Thus, there is a need for systems for transferring maps to a mobile device without network connectivity.

### BRIEF SUMMARY

Certain embodiments are described that provide a mobile device including a scanner for scanning a passive data source, the passive data source comprising an embedded or encoded map. Further embodiments comprise generating the map and displaying it to the user.

In some embodiments, a method for transferring maps to a mobile device without network connectivity using matrix bar codes or other passive data media comprises: receiving data from an image scanner configured to scan a bar code, the data comprising an encoded map wherein none of the data is received from a connection to a network; processing the data to generate the map; and displaying the map to a user.

### BRIEF DESCRIPTION OF THE DRAWINGS

Aspects of the disclosure are illustrated by way of example. In the accompanying figures, like reference numbers indicate similar elements, and:

FIG. 1 illustrates a simplified diagram of a system that may incorporate one or more embodiments;

FIG. 2 illustrates an example of a passive data source;

FIG. 3 illustrates an example of a map that may be encoded in a passive data source;

FIG. 4 illustrates an example of a computing device displaying a map that may be embedded in a passive data source; and

FIG. 5 is a flow chart of the stages of a method for transferring maps to a mobile device without network connectivity using a passive data source.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

Modern offices and public buildings often have complicated layouts, which are not easy to navigate without a map. Oftentimes large buildings present these maps as printed leaflets at an entrance or a printed board within the building. Or, in some other cases, digital maps may be downloaded from the internet. Each of these solutions has problems.

Printed maps may waste paper and must be continuously resupplied. Furthermore, if there is any update to the building (e.g. a store changes) then the old copies of these maps must be discarded, which again leads to waste. Furthermore, there is no interactivity in these maps, so the user's position at any given time is not known.

Similarly, maps that are downloaded from the internet have their own problems. First there must be a network connection in order to download the map. In many locations this network connection is not available, or the user may not have the required data plan to download the map. Furthermore, even if the user has a data connection, the user still must search the internet for the map.

A map printed on a board at the entrance cannot be taken with the user. Thus, these maps are of no use when the visitor is inside the building and has forgotten the layout of the complex.

The present disclosure contemplates a solution to the above problems which allows the user to obtain a digital map on his or her mobile device (e.g. smartphone or tablet) without ever needing to access a network connection. In an illustrative embodiment of the present disclosure, data may be encoded in a marker. In some embodiments, this marker may comprise a passive data source, such as a matrix barcode, a QR code, an RFID tag, or an NFC tag. These types of passive data sources can store enough data to contain a map for a building. For example, in some embodiments, QR codes can store up to about 3000 bytes of data. Depending on the type of rendering used, this can be enough data to display a grid of lines representing up to 300 rooms within a building. In some embodiments, these lines may be rendered to draw various rooms within a building or campus. For example, embodiments of the present disclosure may be used in buildings such as: shopping centers, office complexes, government buildings, hospitals, airports or train stations, a ship, a warehouse, an office, a loading area, an amusement park, a bus terminal, a metro station, a metro system, or other area associated with the map. Similarly such a passive data source could be used to provide data showing a map of a city or a town, or points of interest within the city or the town.

Thus, in an illustrative embodiment of the present disclosure, a passive data source comprising an embedded map may be placed at the entrance of a building, such as a shopping center. In such an embodiment, when users enter the shopping center, they may scan the passive data source with a mobile device comprising a scanner. For example, the user may scan the passive data source using a mobile device such as a smartphone or tablet comprising a QR or multidimensional bar code scanning application that uses sensors commonly found on mobile devices. Upon scanning the passive data source, a processor in the mobile device may then process the data stored in the passive data source, and determine the data comprises an encoded map. For example in one embodiment, the data may comprise a header that identifies the data as a map. In such an embodiment, the processor may further render an image of the map using a display of the mobile device.

In some embodiments, the map may comprise a series of lines and text. For example, in some embodiments, the map features, comprise multiple “nodes” and “paths.” In such an embodiment, nodes are points representing for example intersections of roads, or wall corners and ends. Further, in such an embodiment, paths are lines between nodes representing actual paths of road or, or in buildings, walls. In some embodiments, a set of walls defining the building would be encoded as a sequence of nodes and paths. In further embodiments, text may be displayed around the paths or areas enclosed by the paths. For example, in some embodiments, this text may identify rooms within a building or buildings on a map of a town. In another embodiment, this text may identify the names of stores in a shopping center.

Furthermore, in some embodiments of the present disclosure, once the map is displayed, other functionality, such as Satellite Positioning Systems (“SPS”), Assisted Global Positioning Systems (“AGPS”), or other positioning systems may be used to show the user's location in the map. For example, in one embodiment, as the user moves throughout locations identified on the map, an image or other representation of the user may be shown moving on the map. In some embodiments, the user's movement may be determined based in part on sensors such as accelerometers or velocity sensors. For example, in one embodiment, as the user moves an accelerometer may detect the user's movement, and the distance that the user has traveled may be determined based on signals received from the accelerometer. In such an embodiment, user's movements may be shown by moving an image or other representation within the map.

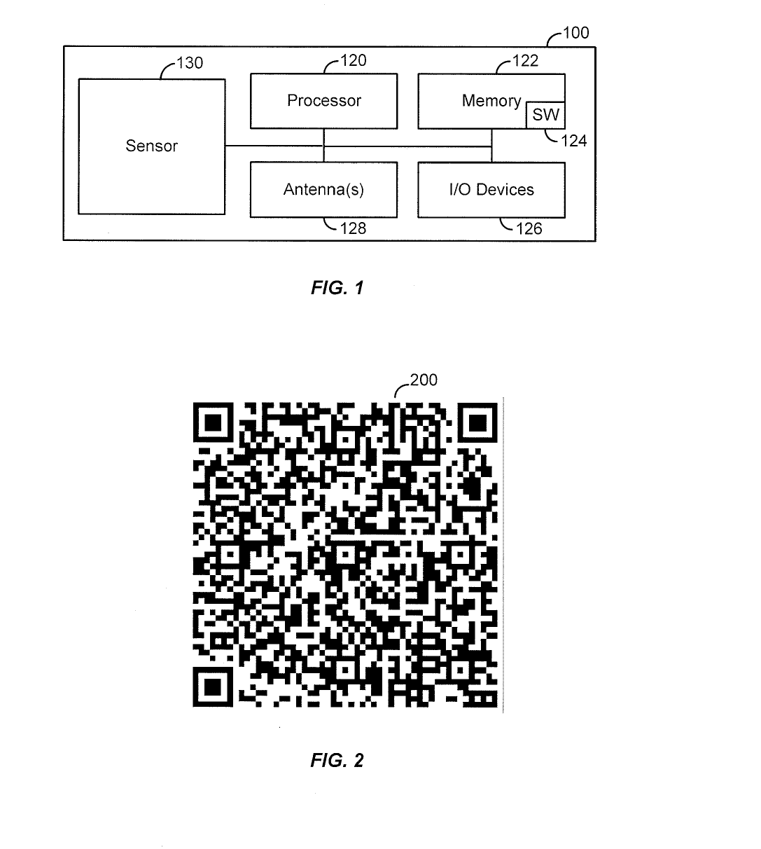

Turning now the Figures, FIG. 1 illustrates a simplified diagram of a system 100 that may incorporate one or more embodiments. As shown in FIG. 1, system 100 comprises one embodiment of a computer system, for example a mobile device such as a smartphone, tablet, handheld computer, laptop computer, or other portable computing device. In the embodiment shown in FIG. 1, system 100 comprises a processor 120, memory 122 including software 124, input/output (I/O) device(s) 126 (e.g., a display, speaker, keypad, touch screen or touchpad, etc.), one or more antennas 128, and sensor 130.

Sensor 130 is a sensor configured to detect a passive data source. For example, in one embodiment, sensor 130 may comprise an optical sensor. In such an embodiment, processor 120 may use sensor 130 to take an optical image of a passive data source, e.g., a matrix barcode such as a QR code, bar code, or multidimensional bar code. In such an embodiment, processor 120 may use software 124 to determine map data from the matrix bar code. In other embodiments, sensor 130 may comprise a sensor configured to detect an RFID tag or an NFC tag. In such an embodiment processor 120 may use software 124 to generate a map, for example, by extracting data embedded in the bar code, RFID tag, or NFC tag.

The antenna(s) 128 provide communication functionality for the device 100 and facilitate bi-directional communication with transmission networks, for example, cellular, data, or SPS networks. The processor 120 is an intelligent hardware device, e.g., a central processing unit (CPU) such as those made by Intel® Corporation or AMD®, a microcontroller, an application specific integrated circuit (ASIC), etc. The memory 122 includes non-transitory storage media such as random access memory (RAM) and read-only memory (ROM). The memory 122 stores the software 124 which is computer-readable, computer-executable software code containing instructions that are configured to, when executed, cause the processor 120 to perform various functions described herein. Alternatively, the software 124 may not be directly executable by the processor 120 but is configured to cause the computer, e.g., when compiled and executed, to perform the functions. In other embodiments, not shown in FIG. 1, device 100 may comprise additional components, such as motion detectors or accelerometers that processor 120 may use to determine movement of device 100.

FIG. 2 illustrates one embodiment of a passive data source according to an embodiment of the present disclosure. Shown in FIG. 2 is a passive date source in the form of QR code 200. In other embodiments, rather than a QR-code, the passive data source may comprise a radio frequency identification tag, near field communication tag, or multi-dimensional bar code. In some embodiments, passive data sources, such as QR code 200 can store up to about 3000 bytes of data. Depending on the type of rendering used, this can be enough data to display a grid of lines representing up to 300 rooms within a building. Thus, in some embodiments, QR code 200 may comprise an embedded or encoded map of a building or campus. For example, embodiments of the present disclosure may be used in buildings such as: shopping centers, office complexes, government buildings, hospitals, airports or train stations, a ship, a warehouse, an office, a loading area, an amusement park, a bus terminal, a metro station, a metro system, or other area associated with the map. Similarly such a passive data source could be used to provide data showing a map of a city or a town, or points of interest within the city or the town.

In one embodiment, device 100 described above with regard to FIG. 1, is configured to scan QR code 200, and using processor 120 and software 124, determine the map stored in QR code. Device 100 is further configured to render the map on I/O device 126, for example a display or touch screen display.

FIG. 3 illustrates an example of a map that may be embedded or encoded into a passive data source such as QR code 200. As shown in FIG. 3, map 300 comprises multiple nodes and paths that form an interior map for a shopping center. For example, in map 300 nodes may comprise points representing intersections wall corners and ends. Further, the map 300 includes text identifying the names of stores within the shopping center. For example, as shown in map 300, the shopping center comprises three stores as well as a food court. The map further comprises text identifying entrances and exits as well as elevators. In other embodiments, the map 300 may comprise additional features such as additional stores, entrances, bathrooms, elevators, escalators, or other features associated with the type of building.

Further, as shown in FIG. 3, map 300 comprises an X labeled “you are here” marking the location of the user. In some embodiments, this may be the location at which the user scanned the passive data source. In other embodiments, the user's computing device may further comprise location capability, and be able to determine its location from one or more of a plurality of available positioning signals, e.g. SPS signals, wireless data signals, or cellular signals. In such an embodiment, the device may be configured to track the user's movement on map 300, by moving an identifier of the user's current location as the user moves across the locations shown in the map. Further, in some embodiments, the device may comprise an accelerometer or velocity sensor configured to detect the user's movement, without reception of a wireless signal. In such an embodiment, the device may be configured to track the user's movement on map 300, by moving an identifier of the user's current location based on the user's acceleration and velocity as the user moves across the map

In other embodiments, rather than a map of a shopping center, the embedded map may comprise a map of, for example, office complexes, government buildings, hospitals, airports or train stations, a ship, a warehouse, an office, a loading area, an amusement park, a bus terminal, a metro station, a metro system, or other area associated with a map. In these other embodiments, the map may comprise features of these locations, for example, natural features (e.g. trees, bushes, flowers, rivers, streams, lakes, or ponds) or man-made features (e.g. buildings, roads, trails, sidewalks, train tracks, or monuments).

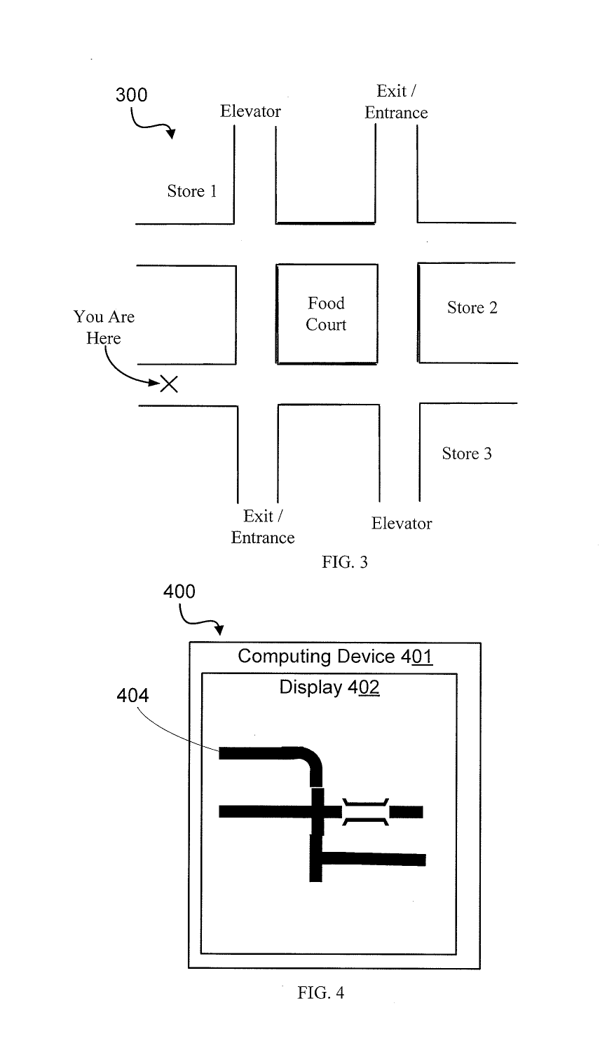

FIG. 4 illustrates an example of a map that may have been embedded or encoded into a passive data source such as QR code 200 displayed on a mobile device. As shown in FIG. 4, system 400 comprises a computing device 401, with a display 402. In some embodiments, display 402 may comprise a touch screen display. As shown in FIG. 4, display 402 comprises a map 404 of the type described above with regard to FIGS. 2 and 3.

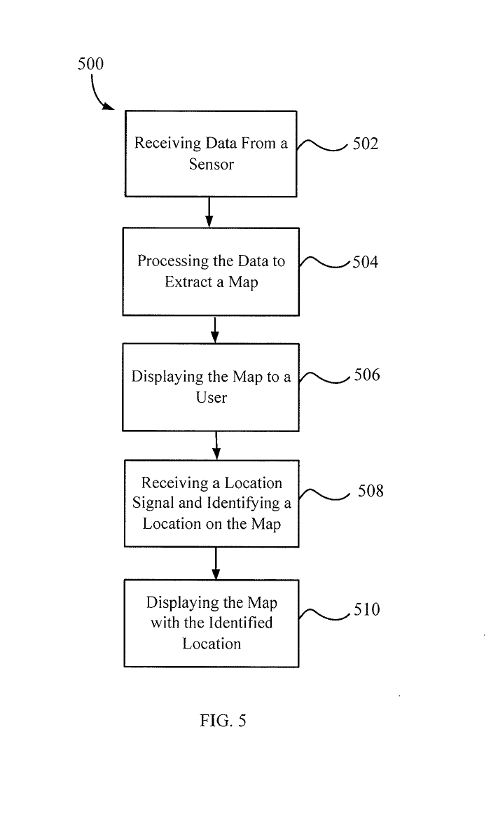

FIG. 5 is a flow chart of the stages of a method for transferring maps to a mobile device without network connectivity using matrix bar codes or other passive data media. In some embodiments, the stages in FIG. 5 may be implemented in program code that is executed by a processor, for example, the processor in a general purpose computer or server. In some embodiments, these stages may be implemented by a group of processors. The stages shown in FIG. 5 are described with regard to the components of system 100 shown in FIG. 1.

The method 500 begins at stage 502 when processor 120 receives data from sensor 130. In some embodiments, sensor 130 may comprise an optical sensor, for example a camera on a smart phone or tablet. In such an embodiment, processor 120 may use sensor 130 to take an optical image of passive data source, e.g., a matrix barcode such as a QR code, bar code, or multidimensional bar code. In other embodiments, sensor 130 may comprise a sensor configured to detect an RFID tag or an NFC tag.

The method 500 continues to stage 504 when processor 120 processes the data to generate map. In some embodiments, generating the map may comprise extracting a map encoded or embedded in the passive data source. In some embodiments, the map data may comprise a header that identifies it as a map. In some embodiments, the map may be encoded using a known method of encoding, for example, one of the standards for encoding data in a QR code. In such an embodiment, processor 120 may execute program code configured to decode data stored in a QR code to generate the map.

The method 500 continues to stage 506 when processor displays the map to a user using I/O device 126. In some embodiments I/O device 126 may comprise a display, for example, a touch screen display. In such an embodiment, processor 120 displays the map to the user using the display.

The method 500 continues to stage 508 when processor 120 receives a location signal identifying a location on the map. For example, antenna(s) 128 may provide communication functionality for the device 100 and facilitates bi-directional communication with transmission networks, for example, cellular, data, or SPS networks. Based on one or more signals received via antennae 128, processor 120 may determine the user's location and movements on the displayed map.

The method 500 continues to stage 510 when processor displays the map with the identified location. For example, the processor may display the map on I/O device 126, which as discussed above, in some embodiments may comprise a display, for example, a touch screen display. Processor 120 may further be configured to display a feature on the display that identifies the user's present location on the map. As the user moves, processor 120 may further be configured to move the user's location a corresponding amount on the map.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered. Accordingly, the above description does not bound the scope of the claims.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Embodiments in accordance with aspects of the present subject matter can be implemented in digital electronic circuitry, in computer hardware, firmware, software, or in combinations of the preceding. In one embodiment, a computer may comprise a processor or processors. The processor comprises or has access to a computer-readable medium, such as a random access memory (RAM) coupled to the processor. The processor executes computer-executable program instructions stored in memory, such as executing one or more computer programs including a sensor sampling routine, selection routines, and other routines to perform the methods described above.

Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example tangible computer-readable media, that may store instructions that, when executed by the processor, can cause the processor to perform the steps described herein as carried out, or assisted, by a processor. Embodiments of computer-readable media may comprise, but are not limited to, all electronic, optical, magnetic, or other storage devices capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other devices may include computer-readable media, such as a router, private or public network, or other transmission device. The processor, and the processing, described may be in one or more structures, and may be dispersed through one or more structures. The processor may comprise code for carrying out one or more of the methods (or parts of methods) described herein.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed is:

1. A method comprising:
receiving data from an image sensor configured to scan a bar code, the bar code comprising a complete encoded map;
processing the data to generate a decoded map; and
displaying the decoded map to a user.

2. The method of claim 1, wherein the decoded map is configured to identify the user's present location in a building.

3. The method of claim 1, further comprising receiving a positioning signal and identifying the user's location on the decoded map based at least in part on the positioning signal.

4. The method of claim 2, wherein the decoded map is configured to identify other locations within the building.

5. The method of claim 1, wherein the bar code comprises a multidimensional bar code.

6. The method of claim 5, wherein the multidimensional bar code comprises a QR code.

7. The method of claim 1, wherein the bar code comprises a header identifying the data as map data.

8. An apparatus comprising:
an image sensor configured to scan bar code and transmit data stored in the bar code, the bar code comprising a complete encoded map;
a processor configured to:
receive the data;
determine a decoded map based on the data;
output a display signal; and
a display configured to receive the display signal and display the decoded map to a user.

9. The apparatus of claim 8, wherein the decoded map is configured to identify the user's present location in a building.

10. The apparatus of claim 8, wherein the processor is further configured to receive a location signal and identify the user's location on the decoded map based at least in part on the location signal.

11. The apparatus of claim 9, wherein the decoded map is configured to identify other locations within the building.

12. The apparatus of claim 8, wherein the bar code comprises a multidimensional bar code.

13. The apparatus of claim 12, wherein the multidimensional bar code comprises a QR code.

14. The apparatus of claim 8, wherein the bar code comprises a header identifying the data as map data.

15. The apparatus of claim 8, wherein the apparatus comprises a mobile device.

16. A non-transient computer readable medium comprising program code, which when executed by the processor, causes the processor to:
receive data from an image sensor configured to scan a bar code, the data comprising a complete encoded map;
process the data to generate a decoded map; and
display the decoded map to a user.

17. The non-transient computer readable medium of claim 16, wherein the decoded map is configured to identify the user's present location in a building.

18. The non-transient computer readable medium of claim 16, wherein the computer readable medium further comprises program code, which when executed by the processor, causes the processor to:
receive a location signal and identify the user's location on the decoded map based at least in part on the location signal.

19. The non-transient computer readable medium of claim 17, wherein the decoded map is configured to identify other locations within the building.

20. The non-transient computer readable medium of claim 16, wherein the bar code comprises a multidimensional bar code.

21. The non-transient computer readable medium of claim 20, wherein the multidimensional bar code comprises a QR code.

22. An apparatus comprising:
a sensing means configured to scan a bar code and transmit data stored in the bar code, the bar code comprising a complete encoded map;
a processing means configured to:
receive the data;
determine a decoded map based on the data;
output a display signal; and
a display means configured to receive the display signal and display the decoded map to a user.

23. The apparatus of claim 22, wherein the decoded map is configured to identify the user's present location in a building.

24. The apparatus of claim 22, wherein the processing means is further configured to receive a location signal and identify the user's location on the decoded map based at least in part on the location signal.

25. The apparatus of claim 22, wherein the decoded map is configured to identify other locations within the building.

26. The apparatus of claim 22, wherein the bar code comprises a multidimensional bar code.

27. The apparatus of claim 26, wherein the multidimensional bar code comprises a QR code.

28. The apparatus of claim 22, wherein the bar code comprises a header identifying the data as map data.

29. The apparatus of claim 22, wherein the apparatus comprises a mobile device.
